(19) United States
(12) Patent Application Publication
(10) Pub. No.: US 2020/0189513 A1
(43) Pub. Date: Jun. 18, 2020

(54) FAR SIDE CRASH MITIGATION

(71) Applicant: Key Safety Systems, Inc., Sterling Heights, MI (US)

(72) Inventors: Matthias Volkmann, Kronberg (DE); Martin Pieruch, Hochheim (DE)

(21) Appl. No.: 16/220,263

(22) Filed: Dec. 14, 2018

(51) Int. Cl. B60R 21/231; B60R 21/207

(52) U.S. Cl. CPC B60R 21/23138; B60R 2021/0006; B60R 21/207

(57) ABSTRACT

A system has a seat having a seat back with a first back portion of the seat back positioned toward the interior of a passenger compartment of the vehicle, a frame member located in the first back portion, an airbag module having an inflator secured to a frame member and an airbag operatively connected to the inflator. When inflated, a first portion of the airbag extends forward of the first back portion of the frame to interfere with movement of an occupant resulting from a far side vehicle crash and the airbag has a second portion wherein an edge portion of the second portion is secured to the frame rearward of the inflator.

### TECHNICAL FIELD

This invention relates to an inflatable airbag system, more particularly to an airbag system helpful in mitigating injuries to an occupant resulting from a far side vehicle crash.

### BACKGROUND OF THE INVENTION

In a conventional vehicle there could be an occupant seated adjacent each side of the vehicle. If the vehicle is struck on the side of the vehicle adjacent the occupant, injuries are mitigated upon inflation of a seat mounted airbag as well as a curtain airbag both of which are interposed between the occupant and an adjacent vehicle interior side. The operation of these types of airbag is based upon using an adjacent vehicular side as a reaction surface to keep the airbag in place, and to cushion the movement of the occupant. FIG. 1 shows a typical front row of a passenger vehicle and illustrates how a driver 300 and a passenger 302 move within a passenger compartment when subjected to a side impact originating on the passenger side of the vehicle as shown by force vector F. Both the driver 300 and passenger 302 seated upon a seat and are protected by a 3-point seat belt system comprising a shoulder belt 304 and lap belt 304a. FIG. 1 diagrammatically shows two exemplary airbags 306 and 308 which provide side impact protection to the occupants. Arrow 310 illustrates the direction the passenger 302 occupant moves in this type of side impact which can also be referred to as a near side impact in relation to the passenger 302. In this lateral impact as illustrated by arrow F, airbag 306 which inflate to protect the passenger 302. Arrow 312 shows how the driver will move in response to this type of crash. This type of impact in relation to the driver is called a far side impact. If the impact occurred on the driver side of the vehicle, this type of crash in relation to the passenger would also be called a far side impact or crash.

In this type of far side impact the driver 300 will move toward the impacted far side of a vehicle. As diagrammatically illustrated the driver 300 or if the impact originated on the driver side of the vehicle the passenger 302 will move dramatically over the middle console 311 toward the force F of the impact, and in certain situations for example involving a rollover of the vehicle the driver 300 and passenger 302 may impact one another aggravating the injuries as this protection system does not include any airbag located in between the passenger 302 and driver 300.

In view of the description above there is a need to properly protect each vehicle occupant in a far side impact. Conceptually, placing another airbag near the center console of the vehicle to protect the driver or passenger in a far side crash is a logical extension of airbag technology however upon an examination of FIG. 1 it is evident there is no reaction surface for a center located airbag to react against and limit occupant motion. One key enabling the side airbags 306 and 308 to protect a respective occupant is the use of the side of the vehicle as a reaction surface.

The prior art has provided some far side safety systems. US20170182969A1 is representative of a far side solution using tension members or tethers to keep the far side airbag in place when in contact with the occupant. The tension members keep the airbag generally in place and react against the force of the occupant. US901716 shows the use of external tethers in combination with a second inflatable pillow reacting against the center console. US9004526 a far side airbag interacting with a descending portion of the vehicle's roof to provide the needed support which reduces the usable room in the vehicle.

It is an object of the present invention to provide the new and inventive approach to mitigate injuries resulting from a far side crash.

### SUMMARY OF THE INVENTION

One of the features of the present invention is an airbag system does not employ tethers to maintain a far side airbag in place and one that does not need to interact with a roof or console to create a reaction force against which the far side airbag can react.

More particularly the invention includes: a system helpful in mitigating injuries to an occupant resulting from a far side vehicle crash, the system comprising: a seat having a seat back with a first back portion of the seat back positioned toward the interior of a passenger compartment of the vehicle, a frame member located in the first back portion, an airbag module having an inflator secured to a frame member, an airbag operatively connected to the inflator such that when inflated a first inflatable portion of the airbag extends forward of the first back portion of the frame to interfere with movement of an occupant resulting from a far side vehicle crash and the airbag has an second inflatable portion wherein an edge portion of the second inflatable portion is secured to the frame rearward of the inflator and wherein the second inflatable portion when inflated is located rearward of the inflator as well as rearward of the first inflatable portion of the airbag to create a counter force or counter torque on the airbag to react against the occupant. The airbag is preferably L-shaped when inflated.

### BRIEF DESCRIPTION OF THE DRAWINGS

FIG. 1 illustrates the movement of a vehicle passenger in a near side and a far side accident.

FIG. 2 diagrammatically shows a top view above the front row of the typical vehicle.

FIG. 3 shows the placement of the prior art side airbag prior to deployment.

FIG. 4 shows a prior art side airbag during deployment.

FIG. 5 diagrammatically shows a plan view of an airbag usable with the present invention.

FIG. 6 shows the placement of a conventional uninflated side airbag in an outer wing or side of a driver side seat and the placement of the present invention in the inner wing or side of the driver side seat.

FIG. 7 shows the airbag fully inflated and first portion extends forwardly toward the front of the vehicle through the inward or inboard facing side or wing of the seat back.

FIG. 8 shows an isometric view of a portion a seat showing the present invention secured to the frame of a seat.

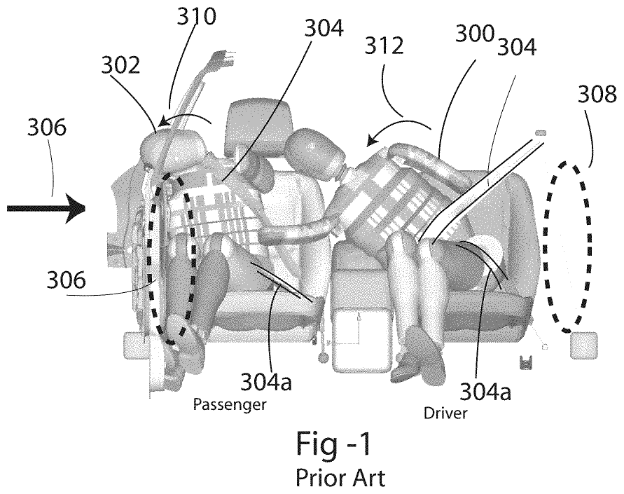

### DETAILED DESCRIPTION OF THE DRAWINGS

During a far side impact a high level of forces are introduced into the occupant's body which induces exaggerated and forceful movements of the chest and more particularly the neck and head. The typical side airbag traditionally mounted to the seat back is installed to the frame of the seat, often using the inflator as the mounting mechanism. The inflated airbag, upon impact by an occupant will tend to rotate or move toward the adjacent side of the vehicle about this mounting position which in the normal course of events is prevented by an adjacent interior side panel and window of the vehicle. As mentioned, if, for example, this same airbag were used in an interior side or wing of a seat back where there is no lateral support or reaction surface, the occupant would not be protected.

As will be seen from the description below the present invention does not utilize tethers, or the middle console, or the roof to provide a reaction surface as common in the prior art to keep the far side airbag in place. In this invention the inflator acts as a pivot point which in combination with an extended back portion of the airbag, which is attached to the seat frame, creates upon inflation a counterforce or torque which reduces the tendency of the airbag to rotate when impacted with the occupant, thereby protecting the occupant.

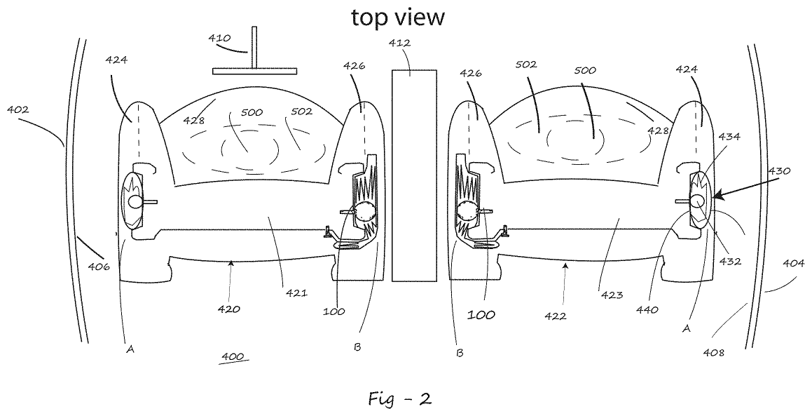

FIG. 2 is a diametric cross-sectional top view of a typical front row of the vehicle showing the passenger compartment 400 with vehicle sides 402 and 404 which include the interior sides 406 and 408 facing within the passenger compartment. A steering wheel 410 and a middle console 412 and a left-hand and right-hand seat 420 and 422 respectively are also shown. Letter A shows the location of a conventional side impact airbag 430 which is located in the outboard side or wing 424 of each seat back 421 and 423. Letter B shows the mounting location of a far side airbag 100 of the present invention adjacent an occupants upper torso 502 within an inboard side or wing 426 of the seat back 421, 423. Each seat 420 and 422 includes a seat cushion 428. The head of each occupant is shown by number 500

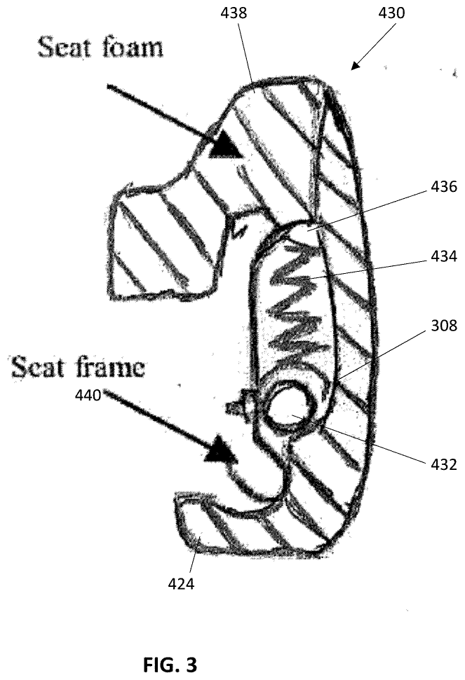

Reference is briefly made to FIG. 3 which illustrates the construction and positioning of a conventional seat back mounted side airbag module. FIG. 3 illustrates an airbag module 430 comprising an inflator 432, airbag 434 and cover 436 located within the upholstery 438 forming the seat back side or wing 424 of the passenger seat near the vehicle side. As illustrated the inflator 432 is secured to a portion of the seat frame identified by 440. As previously mentioned this type of airbag module is positioned in the outboard wing of the seat back at location A adjacent the side of the vehicle.

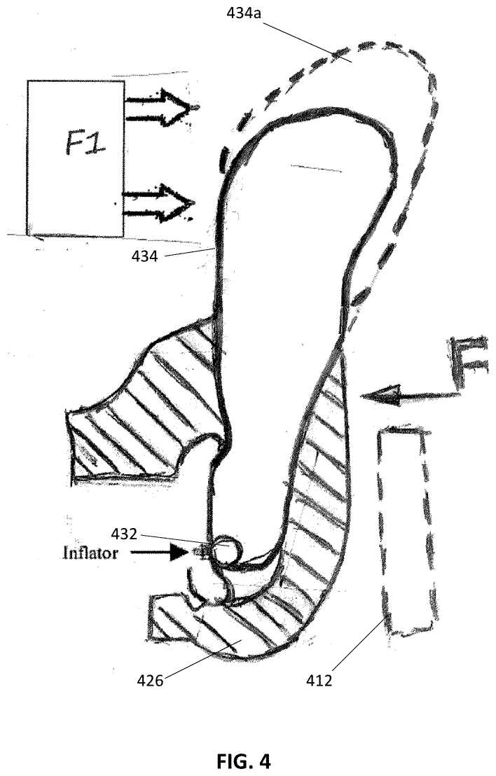

FIG. 4 illustrates airbag 434 however this time located in the inside wing 426 of the driver seat. The airbag is shown in its inflated condition under a predetermined level of pressure which provides some level of rigidity to the airbag. In this example as diagrammatically illustrated in FIG. 4 the conventional airbag module of FIG. 3 is located in the inboard wing of the seat back at position B (shown in FIG. 2) of the driver seat at the location where a far side airbag would be placed. In response to a far side crash designated by a force F received at the exterior side of the vehicle adjacent the passenger, the driver will move into the now inflated airbag 434 with a given level of force identified by F1. The airbag will easily move out of its inflated position as it effectively rotates about the mounting location or is otherwise deformed by the driver, providing no effective protection to the occupant to be protected (driver or passenger) in a far side event. The phantom lines 434a shows movement of the airbag.

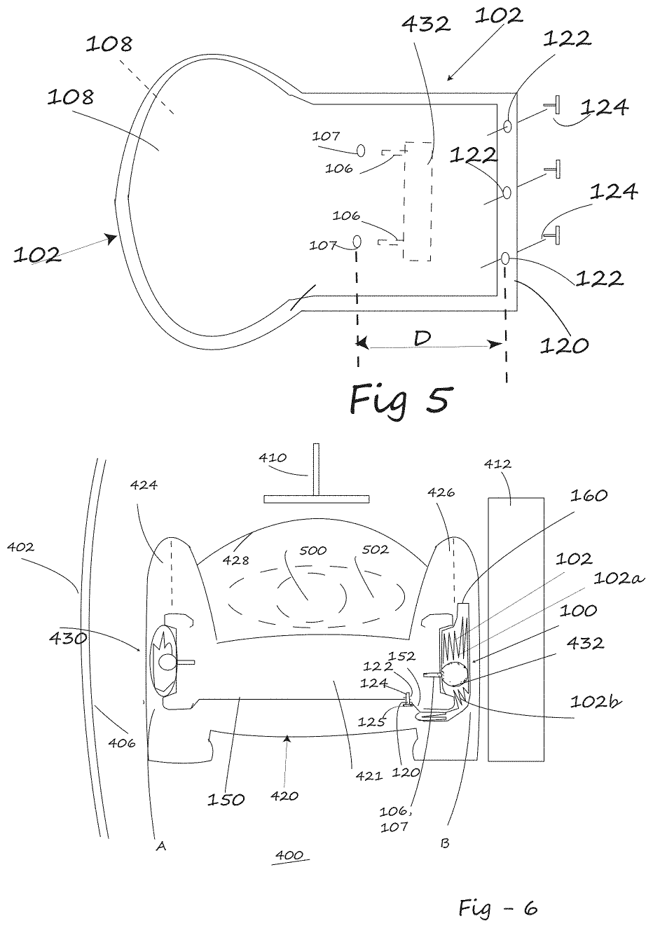

FIG. 5 shows airbag 102 of the present invention in an unfolded condition with an inflator 432. The air bag may be made with two opposing panels of material joined at a selvage region. The airbag includes a rear selvage or reinforced region 120 having a plurality of openings 122 designed to receive a corresponding number of fasteners 124 extend. These fasteners 124, as will be seen secure the selvage region 120 to a rear position of a frame in the seat back. The inflator 432 in positioned within the airbag and mounting studs 106 of the inflator are oriented to protrude through the airbag at openings 107 to the outside of one of the side panels 108 of airbag 102. As will be seen in FIG. 6, these fasteners 124 are used to secure the selvage region 120 of the airbag and to a portion of the seat frame in the wing or side 426. The airbag 102 can have single or multiple inflatable chambers and be of various shapes. What is unique with airbag 102 is that the inflator is not positioned near an end or side of the airbag fabric as in the case of prior art airbags and inflators, but rather spaced a substantial distance D from the selvage end 120 closer in proximity to the enlarged inflatable forward first portion 102a of the airbag 102.

FIG. 6 is representative of a driver side seat 420 having a seat back 423 with airbag module 100 located in the inner side 426, wing or bolster of the seat back. A conventional airbag module such as 430 is located on the outboard side of the seat back. Each airbag module 100 and 430 is secured to a portion of the seat frame 150. In its mounted configuration airbag 102 is shown in a folded condition wherein a first portion or forward extending portion 102a of airbag 102 is located forward of inflator 432. A second portion or base of the airbag 102b generally positioned rearward of the inflator is also positioned in a folded orientation located rearward of inflator 432. As is often the case with side airbag modules the airbag 102 and inflator 432 can optionally be covered by a flexible covering such as a fabric dust cover 160. As mentioned the side or selvage region 120 of the airbag is secured to a flanged portion 152 of the seat frame by the plurality of fasteners 124 expending through openings 122. Another fastener such as a nut 125 can be used to secure the fasteners 124.

As shown, the panel 108 is fixed by the inflator 432 at location L2 and the occupants impact occurs at L1 and upon inflation the panel 108a is tensioned by the general “L” shape of the airbag at the inflated rear portion 102c. This drives the panel 108 inwardly toward the occupant at a much higher level of rigidity.

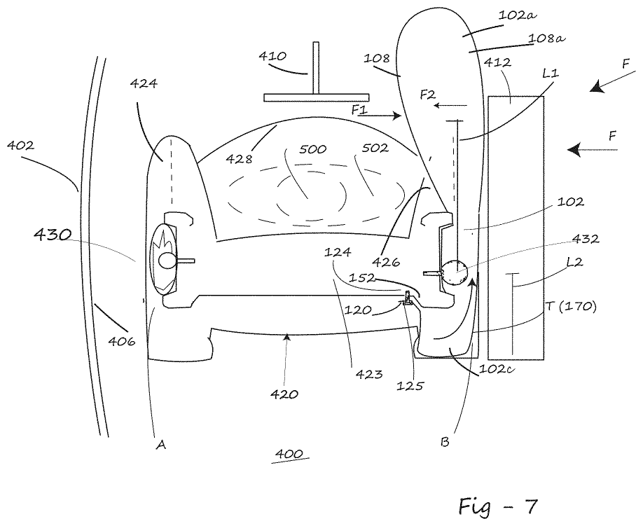

In FIG. 7 airbag 102 is fully inflated and first portion 102a extends forwardly toward the front of the vehicle through the inward or inboard facing side or wing 426 of the seat back 423. In its inflated condition the opposite side panel 108a is positioned apart from side panel 108. The selvage portion 120 of the airbag 102 as previously mentioned is secured to frame portion 152 by fasteners 124 and nuts 125. In its inflated condition second portion 102b of the airbag extends rearwardly of the location of the inflator and seat frame 150 forming an enlarged ballooned portion, this enlarged portion shown by numeral 102c. In the inflated condition airbag 102 is generally L-shaped. In this orientation side airbag 102 of the present invention is filled to a relatively high pressure within the range of 30 kPa 2 about 150 kPa (4.35 psi to about 21.8 psi) yielding a relatively firm and inflexible structure. During the far side crash the occupant will load the inflated airbag with the force F1 tending to push the airbag away from its occupant protecting position toward the impending force F which is shown as a lateral or oblique force F. As mentioned the airbag in this condition is relatively rigid. The applied force F1 of the occupant is resisted by the airbag by a reaction force F2 or torque T transmitted through the airbag; this torque T and is also shown by arrow 170. The reaction force or torque is created as a result of securing the selvage portion of the airbag to the frame. As the rear inflated second portion 102b inflates it reacts with the frame 150, 152 and fasteners 124. This reaction maintains the airbag forwardly oriented toward the front of the vehicle.

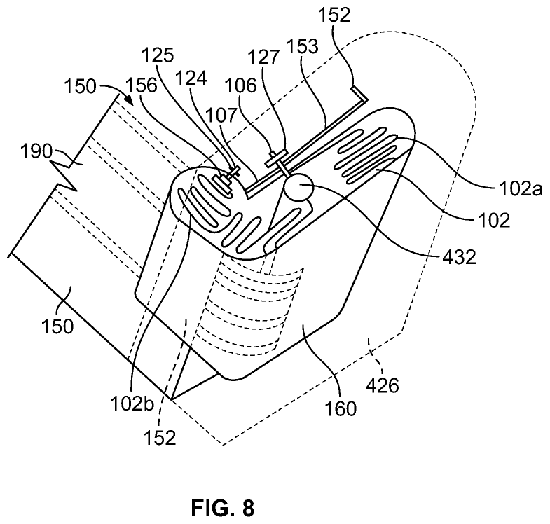

FIG. 8 is an isometric view of the invention shown in FIG. 6. FIG. 8 shows the mounting flange 152 secured to a portion of the seat frame 150. The flange 152 is positioned within the side or wing 426 of the seat back 423. The rear folded airbag second portion 102b is secured thereto flange 152 by the fasteners 124 extending through the selvage region 120. The mounting fasteners 106 of the inflator can be seen extending through a central portion 153 of flange 152 thereby securing the module 100 to the seat. As can also be seen in FIG. 6, the airbag module 100 of the present invention is located within the upholstered side or wing 426 of the seat back 423.

As can be seen from the above, the present invention utilizes the airbag pressure and the exterior of the airbag to create a counter force or counter torque that stabilizes the airbag and prevents it from being moved in the direction of the incoming crash force as the airbag is loaded by the occupant. This counterforce or torque is created impart by the attachment of the inflator to the adjacent frame part of the seat as well as by the rearward or secondary cushion portion 102b which inflates rearward relative to the inflator, as well as rearward of a portion of the adjacent frame. The counterforce or counter torque is enhanced by the L-shaped configuration of the airbag. This counterforce created by the inflated airbag, as shown, cannot be achieved by the standard shaped side airbag. In general the airbag of the present invention will create a counterforce T which is equal to F2*L2=F1*L1, wherein F1 is the force applied by the occupant as he or she impacts the inflated airbag, L1 is the effective distance from the inflator to the point at which the occupant impacts the airbag, L2 is the distance from the inflator to the rear of the inflated bag and where F2 is the reaction force generated at the airbag/frame junction.

The forces imparted by the occupant and absorbed by the airbag are transferred to the frame 150, 152. As can be appreciated it might be necessary to reinforce the seat back with additional framing to prevent frame portion 150 from rotating or otherwise deforming.

Many changes and modifications in the above-described embodiment of the invention can, of course, be carried out without departing from the scope thereof. Accordingly, that scope is intended to be limited only by the scope of the appended claims.

1. A system helpful in mitigating injuries to an occupant resulting from a far side vehicle crash, the system comprising:
a seat having a seat back with a first back portion of the seat back positioned toward the interior of a passenger compartment of the vehicle,
a frame member located in the first back portion,
an airbag module having an inflator secured to the a frame member, the airbag operatively connected to the inflator such that when inflated a first inflatable portion of the airbag extends forward of the first back portion of the frame to interfere with movement of an occupant resulting from a far side vehicle crash and the airbag having a second inflatable portion wherein an edge portion of the second inflatable portion is secured to the frame rearward of the inflator and wherein the second inflatable portion when inflated is located rearward of the inflator as well as rearward of the first inflatable portion of the airbag to create a counter force or counter torque on the airbag to react against the occupant.

2. The system of claim 1 wherein the airbag has two opposing panels of material joined at a selvage region, the selvage region including a rear selvage region with a plurality of openings configured to receive fasteners to secure the rear selvage region to the frame.

3. The system of claim 2 wherein the inflator is positioned inside the airbag and has studs extending through one of the opposed panels and is secured to the frame.

4. The system of claim 2 wherein the inflator is located a distance D from the rear selvage region in proximity to an enlarged portion of the first inflatable portion.

5. The system of claim 2 wherein upon inflation of the airbag the second inflatable portion in combination with the first inflatable portion has an “L” shape.

6. A system helpful in mitigating injuries to an occupant resulting from a far side vehicle crash, the system comprising:
a seat having a seat back with a first back portion of the seat back positioned toward the interior of a passenger compartment of the vehicle,
a frame member located in the first back portion,
an airbag module having an inflator secured to the frame member, an airbag operatively connected to the inflator, wherein the airbag when inflated has an L-shape, wherein a base portion of the L-shaped airbag when inflated is located behind the frame member and wherein a forward extending portion of the L-shaped airbag extends forward of the base portion of the airbag to interfere with the motion of the occupant in a far side vehicle crash.

7. The system of claim 6 wherein the airbag has two opposing panels of material joined at a selvage region, the selvage region including a rear selvage region with a plurality of openings configured to receive fasteners to secure the rear selvage region to the frame.

8. The system of claim 7 wherein the inflator is positioned inside the airbag and has studs extending through one of the opposed panels and is secured to the frame.

9. The system of claim 7 wherein the inflator is located a distance D from the rear selvage region in proximity to an enlarged portion of the forward extending portion.

10. The system of claim 7 wherein upon inflation of the airbag the base portion in combination with the forward extending portion has an “L” shape.

11. An airbag module, comprising an airbag inflator, an airbag, an airbag cover, and (in some cases) a module mounting bracket, secured to a first frame member, and the airbag is attached to both the inflator (or module mounting bracket) and the first frame member using separate attachments mechanisms, the airbag is inflatable from a static condition to an inflated condition in receipt of inflation gas from the inflator, wherein upon inflation the inflated airbag is configured to resist rotation that results from interaction with an occupant in a crash, this resistance to rotation results from the stiffness of the airbag allowing it to act similar to a rigid body, and the 3-dimensional shape of the airbag, the shape of the airbag is such that a base portion of the airbag reacts against the second portion of the first frame member to create a counter-moment equal to that which is imposed by the occupant on a first portion of the airbag.

12. The system of claim 11 wherein the airbag has two opposing panels of material joined at a selvage region, the selvage region including a rear selvage region with a plurality of openings configured to receive fasteners to secure the rear selvage region to the frame.

13. The system of claim 12 wherein the inflator is positioned inside the airbag and has studs extending through one of the opposed panels and is secured to the frame.

14. The system of claim 12 wherein the inflator is located a distance D from the rear selvage region in proximity to an enlarged portion of the first portion.

15. The system of claim 12 wherein upon inflation of the airbag the base portion in combination with the first portion has an “L” shape.

16. A system helpful in mitigating injuries to an occupant resulting from a far side vehicle crash, the system comprising a seat assembly and an airbag module,
the seat assembly having a frame, a seat and seat belt, a seat cushion and a back cushion covering a back portion of the frame, the back portion of the frame having an airbag module attachment first member,
the first member having a first end facing toward a front of the vehicle, a second end facing toward a rear of the vehicle and a middle portion therebetween,
the airbag module comprising an airbag inflator and an airbag, the inflator is secured to the first member, the airbag inflatable from a static condition to an inflated condition in receipt of inflation gas from the inflator,
wherein upon inflation of the airbag the inflated airbag is configured to create a counter-force level-like mechanism in which a first portion of the inflated airbag is presented to receive the occupant in a far side crash to cushion movement of the occupant and in reaction to the interaction with the occupant generate a first reaction force generally opposite to the direction of movement of the occupant and wherein a generally oppositely positioned second portion of the airbag when inflated is positioned against the second end of the first member of the frame, the interaction of the second portion of the airbag with the first member creating a force or moment to supplement the reaction force exerted by the first portion of the airbag.

17. The system of claim 16 wherein the airbag has two opposing panels of material joined at a selvage region, the selvage region including a rear selvage region with a plurality of openings configured to receive fasteners to secure the rear selvage region to the frame.

18. The system of claim 17 wherein the inflator is positioned inside the airbag and has studs extending through one of the opposed panels and is secured to the frame.

19. The system of claim 17 wherein the inflator is located a distance D from the rear selvage region in proximity to an enlarged portion of the first portion.

20. The system of claim 17 wherein upon inflation of the airbag the second portion in combination with the first portion has an “L” shape.
